(19) United States
(12) Patent Application Publication
(10) Pub. No.: US 2014/0109398 A1
(43) Pub. Date: Apr. 24, 2014

(54) AUTOMATIC CAPILLARY REPLACEMENT SYSTEM

(71) Applicant: IL WON CO., LTD., CHUNGCHEONGNAM-DO (KR)

(72) Inventor: Young Kyu Choi, Suwon (KR)

(73) Assignee: IL WON CO., LTD., CHUNGCHEONGNAM-DO (KR)

(21) Appl. No.: 14/087,436

(22) Filed: Nov. 22, 2013

Related U.S. Application Data
(63) Continuation of application No. PCT/KR2011/007027, filed on Sep. 23, 2011.

(30) Foreign Application Priority Data
Jun. 22, 2011 (KR) 10-2011-0060593

(51) Int. Cl. B23P 19/04

(52) U.S. Cl. CPC B23P 19/04
USPC 29/700

(57) ABSTRACT

An automatic capillary replacement system includes a base on which a clamping loader is detachably mounted. A main stage is disposed on the base so as to reciprocate horizontally along the X axis. A sub-stage is disposed on the main stage so as to reciprocate horizontally along the Y axis. A capillary mounting unit is mounted on the sub-stage so as to reciprocate horizontally along the Z axis. A new capillary to be supplied is mounted on the capillary mounting unit. A capillary collecting/supplying unit has a capillary clamper which is movable on the main stage along the X, Y and Z axes. An unclamping unit is disposed on the sub-stage, and selectively releases a clamping part of the clamping loader so that the capillaries can be separated and mounted. First to third drive parts drive the main stage, the sub-stage and the capillary collecting/supplying unit to reciprocate.

### TECHNICAL FIELD

The present invention relates to an automatic capillary replacement system which can automatically replace a capillary with a new one.

### BACKGROUND ART

Wire bonding is one of the processes performed to fabricate a semiconductor package. Wire bonding refers to the process of imparting a semiconductor chip with an electrical characteristic by connecting the semiconductor chip to a substrate using a gold wire through which an electrical signal can be transmitted.

A capillary used in wire bonding is a device that is used in directly bonding the gold wire and making a wire loop. Referring to a sewing machine used for manufacturing clothes by way of example, the capillary acts like a needle, and the gold wire corresponds to thread.

The capillary is an article of consumption, the use of which is limited, and which is required to be replaced depending on the limited use. Referring to a capillary replacement process of the related art, a limited value of the use of a capillary is inputted into a wire bonding apparatus. When the limited use of the capillary is reached, the wire bonding apparatus alerts an operator by creating an alarm. Then, the operator initializes the value of the use of the capillary in the wire bonding apparatus which created the alarm, removes a fixing screw which fixes the capillary, and mounts a new capillary. The capillary replacement process of the related art includes manual labor of the operator.

At sites where actual semiconductor packaging is processed, the number of wire bonding apparatus is frequently several hundred due to characteristics of the wire bonding process. When capillaries are replaced at a plurality of apparatuses during the wire bonding process, significant labor is required, which is problematic. In addition, a lot of time loss is caused during the process of removing capillary-fixing screws and reinstalling such screws. Accordingly, a lot of time and cost is lost during the capillary replacement process.

### SUMMARY OF DISCLOSURE

### Technical Problem

Accordingly, the present invention has been made keeping in mind the above problems occurring in the prior art, and an object of the present invention is to provide an improved automatic capillary replacement system which can automate the process of mounting and releasing a capillary.

### Technical Solution

In order to accomplish the above object(s), the present invention provides an automatic capillary replacement system that includes: a base on which a clamping loader having a clamping part which clamps a capillary at a leading end is to be detachably mounted; a main stage disposed on the base such that the main stage is to reciprocate horizontally along an X axis; a sub-stage disposed on the main stage such that the sub-stage is to reciprocate horizontally along a Y axis that intersects the X axis; a capillary mounting unit mounted on the sub-stage such that the capillary mounting unit is to reciprocate horizontally in a Z-axis direction, wherein a new capillary to be supplied is mounted on the capillary mounting unit; a capillary collecting/supplying unit having a capillary clamper which is movable on the main stage in each of the X, Y and Z axes; an unclamping unit disposed on the sub-stage, wherein the unclamping unit selectively releases the clamping part of the clamping loader so that the capillaries can be separated and mounted; a first drive part which causes the main stage to reciprocate; a second drive part which causes the sub-stage to reciprocate; and a third drive part which causes the capillary collecting/supplying unit along the Y axis.

The capillary mounting unit may include a mounting member having a plurality of mounting recesses in which the capillaries are to be mounted and a first lift drive part disposed on the sub-stage. The first lift drive part selectively moves the mounting member upward and downward.

The capillary collecting/supplying unit may include: a movable block disposed on the main stage so as to be movable reciprocally in the Y-axis direction; a lift block disposed on the movable block so as to be movable reciprocally in the Z-axis direction; a second lift drive part which drives the lift block to move upward and downward; a loader block disposed on the lift block so as to be movable reciprocally in the X-axis direction, wherein the loader block includes a clamper which clamps the capillaries; and a horizontal drive part which reciprocally move the loader block in the Y-axis direction.

The unclamping unit may include: a noncircular release pin which is inserted into an operation space connected to the clamping part of the clamping loader; a lift member which rotatably supports the release pin; a lift drive part disposed on the sub-stage, wherein the lift drive part drives the lift member to move upward and downward; and a pin drive part which rotates the release pin. The clamping part of the clamping loader is spread or narrowed depending on a state of rotation of the release pin in order to clamp or release the capillaries.

The first drive part may include: a first rack gear part disposed on the base; a first drive gear connected to the first rack gear part; and a first drive motor disposed on the main stage, wherein the first drive motor drives the first drive gear to rotate.

The second drive part may include: a second rack gear part disposed on the main stage; a second drive gear connected to the second rack gear part; and a second drive motor disposed on the sub-stage, wherein the second drive motor drives the second drive gear to rotate.

The third drive part may include: a third rack gear part disposed on the main stage; a third drive gear connected to the third rack gear part; and a third drive motor disposed on the capillary collecting/supplying unit, wherein the third drive motor drives the third drive gear to rotate.

### Advantageous Effects

According to the automatic capillary replacement system of the present invention, it is possible to automatically replace a capillary. Accordingly, compared to the manual capillary replacement process of the related art, it is possible to reduce the operation time as well as raise reliability and reduce cost since accurate replacement is possible due to automation.

### DESCRIPTION OF DRAWINGS

FIG. 1a is a perspective view showing an automatic capillary replacement system according to an embodiment of the present invention;

FIG. 1b is a view showing the state in which the main stage has moved in the X-axis direction from the position of FIG. 1a;

FIG. 2 is a view showing the state in which the sub-stage and the capillary collecting/supplying unit have moved in the Y-axis direction from the position of FIG. 1b;

FIG. 3 to FIG. 6 are views illustrating the operation of collecting a used capillary;

FIG. 7 to FIG. 9 are views illustrating the operation of mounting a new capillary;

FIG. 10 is a view showing key parts of the clamping loader shown in FIG. 1a;

FIG. 11 is a schematic top plan configuration view illustrating the first to third drive parts shown in FIG. 1a;

FIG. 12a and FIG. 12b are views illustrating the operation of the release pin drive part shown in FIG. 1a; and

FIG. 13 is a perspective view showing the capillary mounting unit shown in FIG. 1a.

### DETAILED DESCRIPTION

Reference will now be made in detail to an automatic capillary replacement system according to an embodiment of the present invention in conjunction with the accompanying drawings.

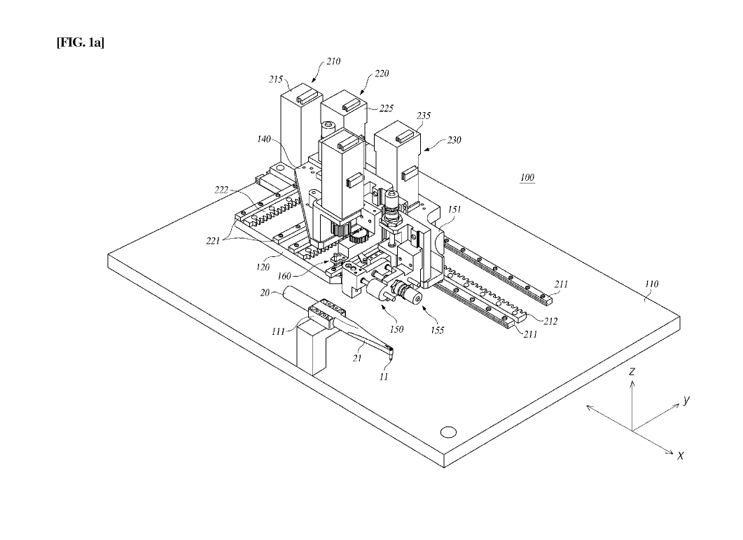

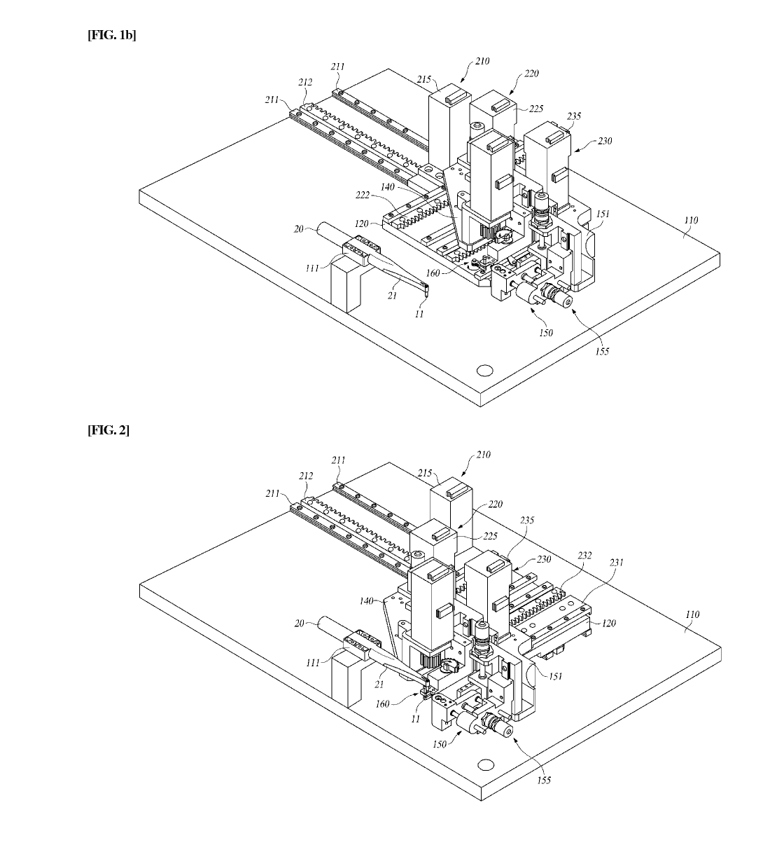

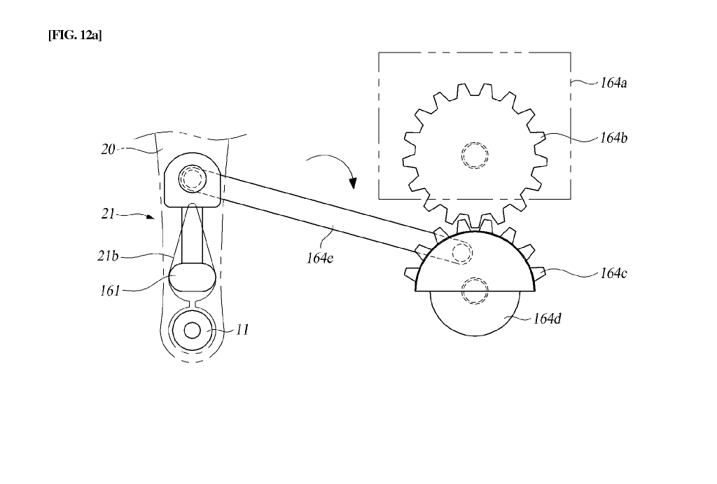

Referring to FIG. 1a to FIG. 13, an automatic capillary replacement system 100 according to the present invention includes a base 110, a main stage 120, a capillary mounting unit 130, a sub-stage 140, a capillary collecting/supplying unit 150, a unclamping unit 160, and first, second and third drive parts 210, 220 and 230. On the base 110, a clamping loader 20 can be detachably mounted. The clamping loader 20 has a clamping part 21 which clamps a capillary 10 at the leading end. The main stage 120 is disposed on the base 110 such that the main stage 120 can reciprocate horizontally in the X-axis direction. A capillary 11 that is movably disposed and has been used on the main stage 120 and a new capillary 12 to be supplied are mounted on the capillary mounting unit 130. The sub-stage 140 is disposed on the main stage 120 such that the sub-stage 140 can reciprocate horizontally in the Y-axis direction that intersects the X-axis direction. The capillary collecting/supplying unit 150 is movably disposed on the main stage 120. The unclamping unit 160 is disposed on the sub-stage 140, and selectively releases the clamping part 21 of the clamping loader 20 so that the capillary 11 can be separated and mounted. The first drive part 210 causes the main stage 130 to reciprocate, the second drive part 220 causes the sub-stage 140 to reciprocate, and the third drive part 230 causes the capillary collecting/supplying unit 150 to reciprocate in the Y-axis.

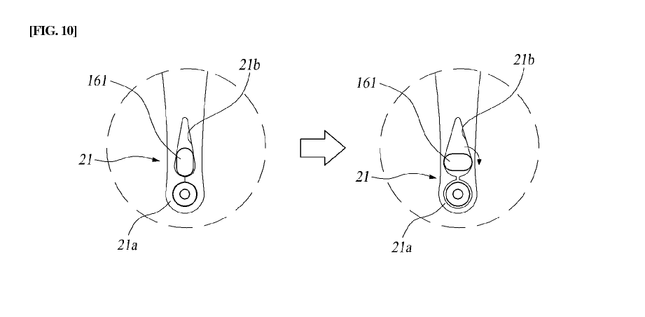

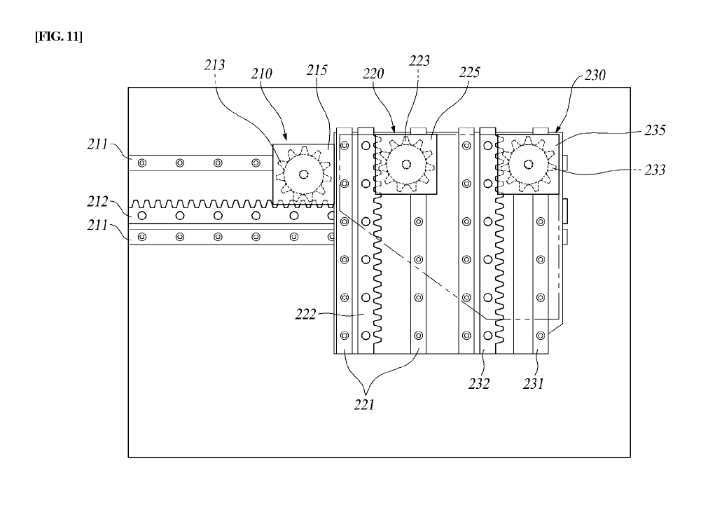

A loader mounting part 111 is disposed on the base 110, and the clamping loader 20 is detachably supported on the loader mounting part 111. The clamping loader 20 is mounted on the loader mounting part 111, and includes the clamping part 21 which clamps the capillary 11 at the leading end thereof by wrapping the outer portion of the capillary 11. As shown in FIG. 10, the clamping part 21 includes a gripper-shaped capillary mounting part 21a and a release pin coupling part 21b. The capillary 11 is inserted into the capillary mounting part 21a which is spread, and the capillary mounting part 21a clamps the capillary 11 while restoring to the original shape due to elasticity. The release pin coupling part 21b is formed to communicate with the capillary mounting part 21a, and has a preset space. When a release pin 161 having a non-circular cross-section of the unclamping unit 160 is inserted into the release pin coupling part 21b and then rotated by about 90°, the capillary mounting part 21a can be forcibly spread by the release pin 161, thereby releasing the capillary 11 which has been clamped. Consequently, the used capillary 11 can be separated from the clamping part 21, and the new capillary 12 can be inserted into the capillary mounting part 21a that is spread.

The main stage 120 is disposed on the base 110 such that the main stage 120 can reciprocate in the X-axis direction. The main stage 120 is driven by the first drive part 210 so as to reciprocate on the base 110. The first drive part 210 includes a first guide rail 211 which is disposed on the base 110, a first rack gear part 212 which is disposed parallel to the first guide rail 211, and a first drive motor 215 which dives a first drive gear 213 meshed with the first rack gear part 212. The first drive motor 215 is disposed on the main stage 120, and may be a stepping motor which can be driven to rotate forward and backward. Driving of the first drive motor 215 can cause the main stage 120 to reciprocate in the X-axis direction through linkage between the first drive gear 213 and the first rack gear part 212.

The sub-stage 140 is disposed on the main stage 120 such that the sub-stage 140 can reciprocate along the Y-axis. The second drive part 220 causes the sub-stage 140 to reciprocate on the main stage 120. Here, the second drive part 220 includes a second guide rail 221 which is disposed on the sub-stage 140, a second rack gear part 222 which is disposed in parallel to the second guide rail 221, a second drive gear 223 gear-connected to the second rack gear part 222, and a second drive motor 225 which drives the second drive gear 223 to rotate. The second drive motor 225 is disposed on the sub-stage 140, and can include a stepping motor which can be driven to rotate forward and backward. With this configuration, when the second drive motor 225 is driven, the second drive gear 223 is driven to rotate, and through linkage between the second drive gear 223 and the second rack gear part 222, the sub-stage 140 can be moved in the Y-axis direction.

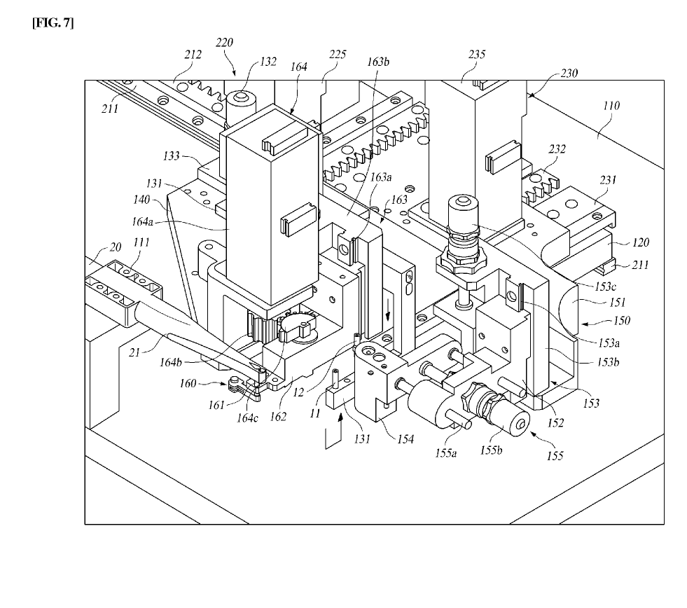

In addition, the capillary mounting unit 130 is disposed on the sub-stage 140 such that the capillary mounting unit 130 can move upward and downward. As shown in FIG. 6 to FIG. 9 and FIG. 13, the capillary mounting unit 130 includes a mounting member 131 having mounting recesses 131a in which a plurality of capillaries is mounted and a first lift drive part 132 which drives the mounting member 131 to move upward and downward. The plurality of mounting recesses 131 are formed at regular intervals in the mounting member 131, and both the capillary 11 which is collected after having been used and the new capillary 12 to be supplied can be respectively mounted in the mounting recesses 131. The first lift drive part 132 includes a hydraulic cylinder 131 which is supported on a support bracket 133 disposed on the sub-stage 140. When the hydraulic cylinder 131 is driven, the hydraulic cylinder 131 drives the mounting member 131 to move upward and downward. As the mounting member 131 is driven to move upward and downward using the first lift drive part 132, the capillary collecting/supplying unit 150 can easily collect the used capillary 11 and easily clamp and supply the new capillary 12. The support bracket 133 has a guide part 133a which guides upward-downward movement of the mounting member 131.

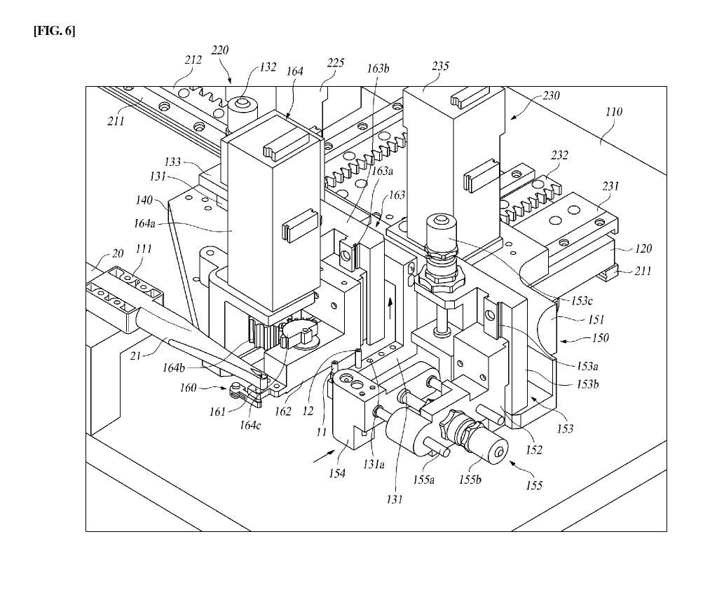

The capillary collecting/supplying unit 150 includes a movable block 151, a lift block 152, a second lift drive part 153, a loader block 154 and a horizontal drive part 155. The movable block 151 is disposed on the main stage 120 such that movable block 151 can reciprocate in the Y-axis direction. The lift block 152 is disposed on the movable block 151 such that the lift block 152 can reciprocate in the upward-downward direction (Z-axis direction). The second lift drive part 153 drives the lift block 152 to move upward and downward. The loader block 154 is disposed on the lift block 152 such that the loader block 154 can reciprocate in the Y-axis direction, and has a clamper 154a (see FIG. 5) which clamps the capillary 11 and 12. The horizontal drive part 155 causes the loader block 154 to reciprocate in the X-axis direction.

The movable block 151 is driven by the third drive part 230 to reciprocate in the Y-axis direction. Here, the third drive part 230 includes a third guide rail 231, a third rack gear 232, a third drive gear 233 and a third drive motor 235. The third guide rail 231 is disposed in the Y-axis direction on the main stage 120 to be parallel to the main stage 120. The third rack gear 232 is disposed parallel to the third guide rail 231. The third drive gear 233 is gear-connected to the third rack gear part 232. The third drive motor 235 drives the third drive gear 233. The third drive motor 235 is preferably a stepping motor which can drive forward and backward. When the third drive motor 235 is driven, the third drive motor 235 can reciprocally move the movable block 151 through linkage between the third drive gear 233 and the third rack gear 232.

The movable block 151 is disposed such that the movable block 151 can reciprocate on the main stage 120 along the third guide rail 231. The third drive motor 235 is disposed on the movable block 151.

The lift block 152 is reciprocally moved in the upward-downward direction, i.e. the Z-axis direction, by the lift drive part 153. The lift drive part 153 includes a support block 153b having a lift rail 153a which guides upward-downward movement of the lift block 152 and a hydraulic cylinder 153c which is disposed on the support block 153b to move the lift block 152 upward and downward. Due to actuation of the hydraulic cylinder 153c, the lift block 152 can be lifted to a preset height along the lift rail 153a. The loader block 154 is connected to the lift block 152 such that the loader block 154 can be reciprocally driven in the horizontal direction, i.e. the Y-axis direction, by the horizontal drive part 155. The clamper 154a is disposed at the leading end of the loader block 154, and when driven, can surround and clamp or unclamp the capillaries 11 and 12. The clamper 154a has a configuration that includes a pair of gripper members which are driven to move toward and away from each other. The clamper 154a can move the capillaries 11 and 12 to a position by clamping the capillaries 11 and 12 using the pair of gripper members, and locate the capillaries 11 and 12 at the moved position by unclamping the capillaries 11 and 12. Since the structure of this clamper 154a can be understood to be the same as the clamper structure of a robot arm which is widely used in the industry, a further detailed description thereof will be omitted.

The horizontal drive part 155 includes a support guide 155a which is slidably disposed on the lift block 152. The loader block 154 is connected to one end of the support guide 155a. The horizontal drive part 155 also includes a hydraulic cylinder 155b which is disposed on the lift block 152, and when driven, selectively moves the loader block 154 in the horizontal direction. The support guide 155a can be provided as a pair of support guides 155a, and the hydraulic cylinder 155b is preferably disposed between the pair of support guides 155a.

The capillary collecting/supplying unit 150 having the above-described configuration is moved along each of the three axes, i.e. the X, Y and Z axes. While being moved along the X, Y and Z axes, the capillary collecting/supplying unit 150 can collect the used capillary 11 which is mounted on the clamping part 21, and mount the capillary 11 on the capillary mounting unit 130 by moving the capillary 11. Afterwards, the capillary collecting/supplying unit 150 can clamp the new capillary 12 which is mounted on the capillary mounting unit 130 and mount the new capillary 12 on the clamping part 21 of the clamping loader 20.

The unclamping unit 160 is intended to make the clamping part 21 of the clamping loader 20 unclamp the capillary 11 so that the capillary 11 is separated from the clamping part 21 and the new capillary 12 can be mounted on the clamping part 21. This unclamping unit 160 includes a lift drive part 163 which moves the lift member 162 upward and downward and a pin drive part 164 which rotates the release pin 161.

The release pin 161 has a noncircular cross-sectional shape, and is rotatably disposed at one end of the lift member 162. This release pin 161 is inserted into the release pin coupling part 21b that is adjacent to the clamping part 21 of the clamping loader 20. When rotated by about 90° in the inserted state, a noncircular operation space 22 can be spread so that the clamping part 21 becomes loose.

The lift member 162 can be moved upward and downward by the lift drive part 163 so that the lift member 162 can move upward and be inserted into the release pin coupling part 21a in the state in which the release pin 161 has moved to the lower portion of the operation space 22 of the clamping loader 20 and be separated at the time of downward movement.

The lift drive part 163 includes a lift guide 163a which guides upward-downward movement of the lift member 162, a guide block 163b having the lift guide 163a, and a hydraulic cylinder 163b which moves the lift member 162 upward and downward. The guide block 163b and the hydraulic cylinder 163b are disposed on the sub-stage 140.

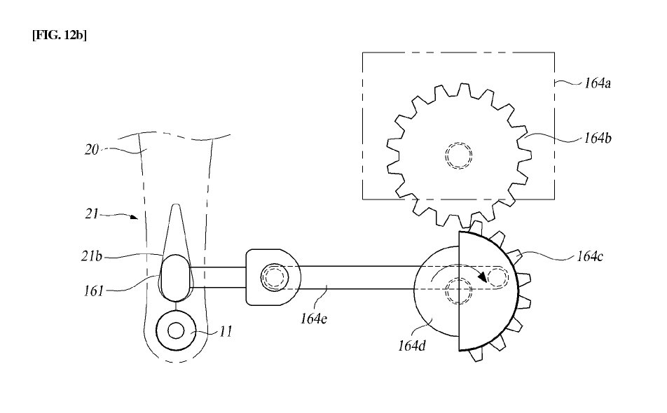

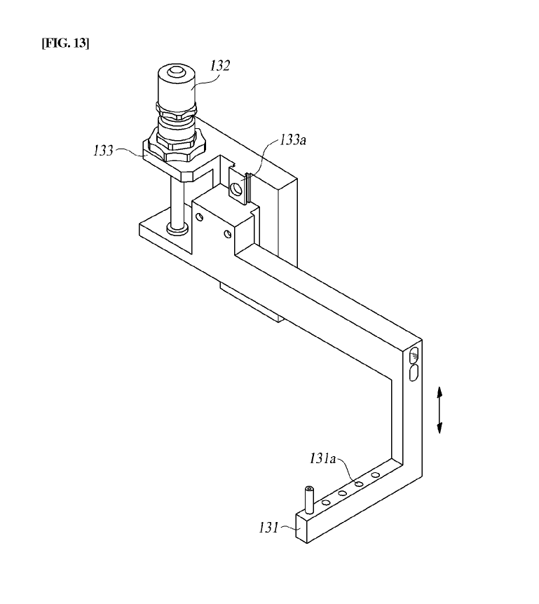

Referring to FIG. 12a and FIG. 12b, the pin drive part 164 includes a sub-pin drive motor 164a and a drive gear 164b connected to a drive shaft of the pin drive motor 164a. The pin drive part 164 also includes a follower gear 164c which is rotatably disposed on the lift member 162 such that the follower gear 164c is movably gear-connected to the drive gear 164b. The pin drive part 164 also includes a turntable 164d which rotates coaxially with the follower gear 164c and a link member 165e which connects the turntable 164d and the release pin 161 to each other. The follower gear 164c is moved upward and downward together with the lift member 162 in the state in which the follower gear 164c is gear-connected to the drive gear 164b, and rotates due to power transmitted from the drive gear 164b. One end of the link member 165e is connected to the center of rotation of the release pin 161, and the other end of the link member 165e is connected to a position to which the turntable 164d which rotates coaxially with the follower gear 164c is offset from the center of rotation. A joint is provided between the two ends of the link member 165e. Due to this configuration of the link member 165e, when the follower gear 164c is rotated, the follower gear 164c can rotate the release pin 161 by a preset angle, preferably, 90°, and restore the release pin 161 to the original position from the rotated position. Accordingly, it is possible to control the operation of releasing the clamping part 21 of the clamping loader 20 using the release pin 161 to be automatically performed.

Reference will now be made in detail to the functions and effects of the automatic capillary replacement system 100 according to an embodiment of the present invention having the above-described configuration.

First, as shown in FIG. 1a, the clamping loader 20 having the used capillary 11 is mounted on the loader mounting part 111 which is provided on the base 110. In this state, the main stage 120 is moved in the X-axis direction, as shown in FIG. 1b, by driving the first drive part 210.

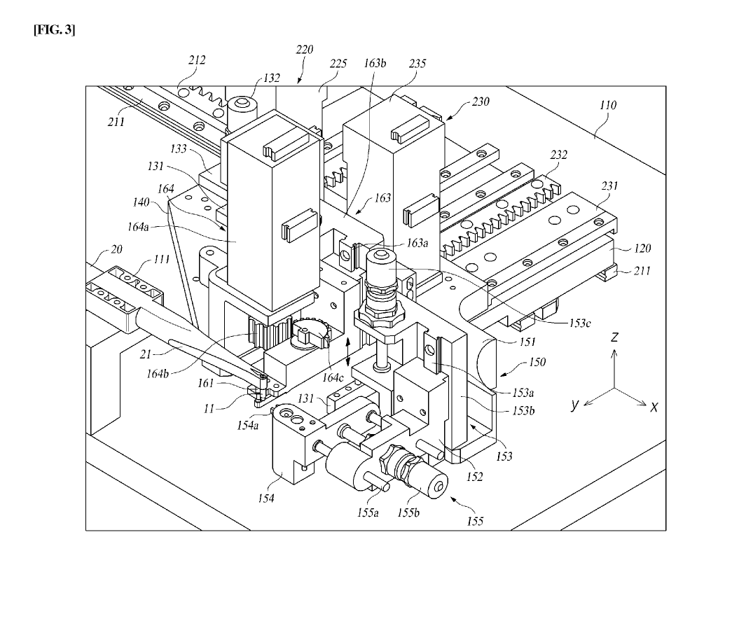

Afterwards, the sub-stage 140 and the capillary collecting/supplying unit 150, also-referred to as the capillary loader unit, are moved in the Y-axis direction and positioned adjacent to the clamping loader 20, as shown in FIG. 2, by driving the second drive part 220 and the third drive part 230.

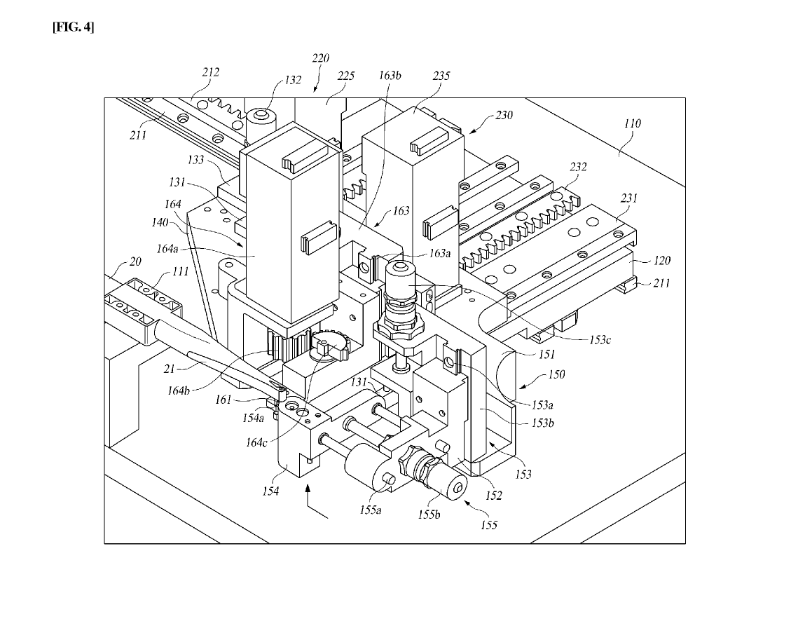

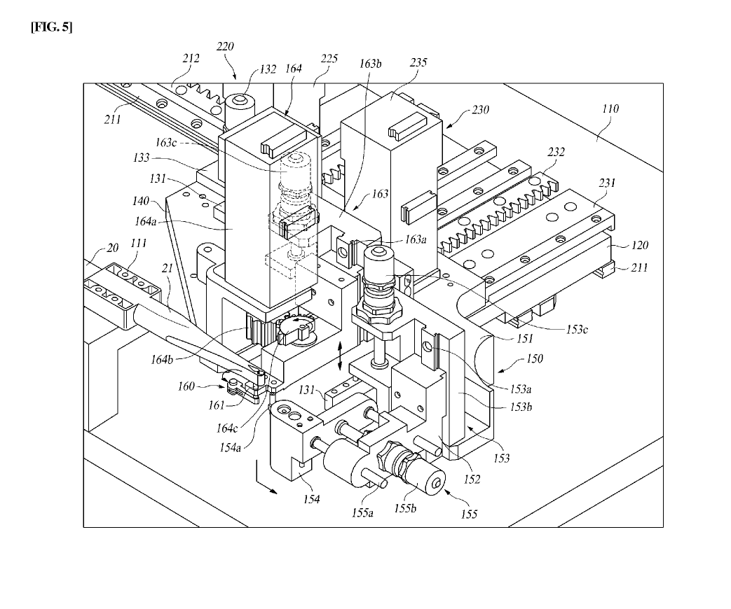

After that, the release pin 161 is inserted into the operation space 22 of the clamping loader 20 by driving the unclamping unit 160. That is, the release pin 161 is inserted into the operation space 22 by moving the lift member 162 upward (see FIG. 3). In this state, the loader block 154 is moved in the X-axis direction and is positioned below the clamping part 21. Afterwards, the loader block 154 is moved again upward so that the clamper 154a of the loader block 154 clamps the capillary 11 which is clamped in the clamping part (see FIG. 4). After the capillary 11 is clamped by the clamper 154a, the pin drive part 164 is driven to rotate the release pin 161 by 90°, as shown in FIG. 10. Then, the noncircular release pin 161 spreads the release pin coupling part 21b, and thus the state of the clamping part 21 clamping the capillary 11 is released. Then, the loader block 154 is moved downward again, is moved backward again (in the X-axis direction, see FIG. 5), and then is moved in the Y-axis direction (see FIG. 6). Consequently, the capillary 11 which has been clamped by the clamping part 21 is separated therefrom, and is positioned on the upper portion of the capillary mounting unit 130.

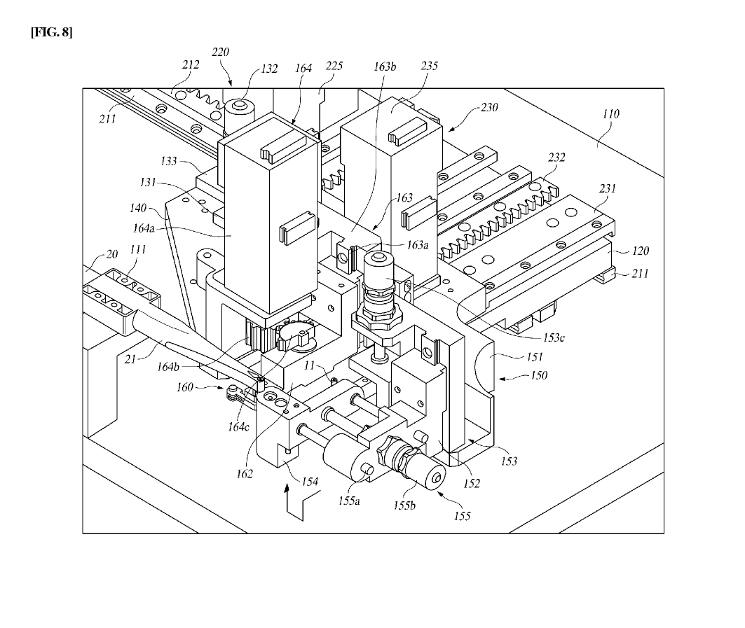

In this state, the capillary 11 is mounted in the mounting recess 131a by moving the capillary mounting unit 130 upward and the loader block 154 downward. After that, when the clamper 154a is released from the clamping position, the collected capillary 11 is mounted in the mounting recess 131a. Afterwards, the loader block 154 is moved to a position corresponding to the new capillary 12 mounted on the capillary mounting unit 130 (see FIG. 7).

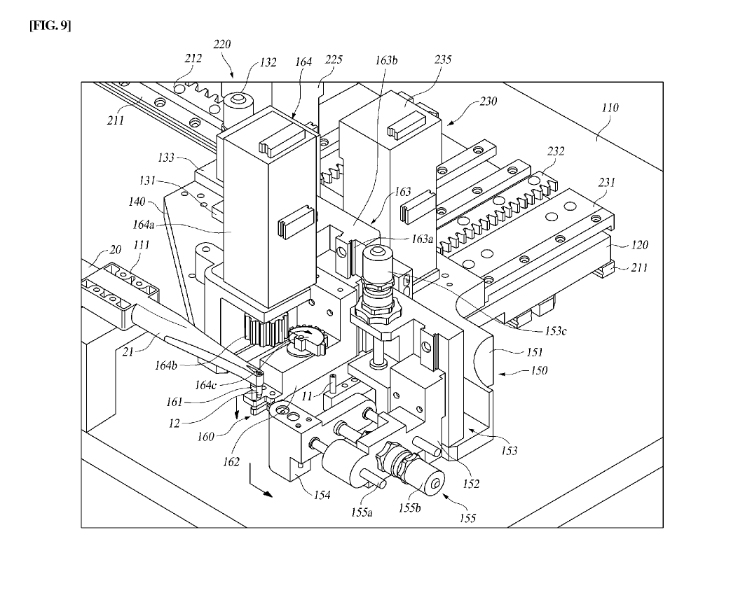

After that movement, the clamper 154a is driven to clamp the new capillary 12. Afterwards, the loader block 154 is moved in the inverse order of the collecting operation so that the capillary 12 is positioned so as to be mounted on the clamping part 21 of the clamping part 21, as shown in FIG. 8.

In the state in which the new capillary 12 is temporarily mounted, the release pin 161 is rotated by 90° to the original position by driving the pin drive part 164. Consequently, the clamping part 22 which has been spread is narrowed, as shown in FIG. 10, and the capillary 12 is strongly clamped and fixed.

When the new capillary 12 is mounted on the clamping loader 20 in this fashion, the clamping state of the clamper 154a is released, and then the loader block 154 is moved to the initial position (see FIG. 9).

In addition, after the release pin 161 is separated from the operation space 22 by moving the lift member 162 downward, the sub-stage 140 and the capillary collecting/supplying unit 150 are moved in the Y-axis direction to the initial position. In sequence, the main stage 120 is moved to the original position, thereby completing the automatic capillary replacement operation.

Although the present invention has been shown and described in conjunction with the exemplary embodiment for the purpose of illustrating the principle of the present invention, the present invention is by no way limited to those configurations and functions that were shown and described above. A plurality of alterations and modifications will be apparent to a person skilled in the art without departing from the principle and scope of the appended Claims.

### DESCRIPTION OF THE REFERENCE NUMERALS IN THE DRAWINGS

11, 12: capillary

20: clamping loader

100: automatic capillary replacement system

110: base

120: main stage

130: capillary mounting unit

140: sub-stage

150: capillary collecting/supplying unit

160: unclamping unit

210: first drive part

220: second drive part

230: third drive part

1. An automatic capillary replacement system comprising:
a base on which a clamping loader having a clamping part which clamps a capillary at a leading end is to be detachably mounted;
a main stage disposed on the base such that the main stage is to reciprocate horizontally along an X axis;
a sub-stage disposed on the main stage such that the sub-stage is to reciprocate horizontally along a Y axis that intersects the X axis;
a capillary mounting unit mounted on the sub-stage such that the capillary mounting unit is to reciprocate horizontally in a Z-axis direction, wherein a new capillary to be supplied is mounted on the capillary mounting unit;
a capillary collecting/supplying unit having a capillary clamper which is movable on the main stage in each of the X, Y and Z axes;
an unclamping unit disposed on the sub-stage, wherein the unclamping unit selectively releases the clamping part of the clamping loader so that the capillaries can be separated and mounted;
a first drive part which causes the main stage to reciprocate;
a second drive part which causes the sub-stage to reciprocate; and
a third drive part which causes the capillary collecting/supplying unit along the Y axis.

2. The automatic capillary replacement system according to claim 1, wherein the capillary mounting unit comprises a mounting member having a plurality of mounting recesses in which the capillaries are to be mounted and a first lift drive part disposed on the sub-stage, wherein the first lift drive part selectively moves the mounting member upward and downward.

3. The automatic capillary replacement system according to claim 1, wherein the capillary collecting/supplying unit comprises:
a movable block disposed on the main stage so as to be movable reciprocally in the Y-axis direction;
a lift block disposed on the movable block so as to be movable reciprocally in the Z-axis direction;
a second lift drive part which drives the lift block to move upward and downward;
a loader block disposed on the lift block so as to be movable reciprocally in the X-axis direction, wherein the loader block comprises a clamper which clamps the capillaries; and
a horizontal drive part which reciprocally move the loader block in the Y-axis direction.

4. The automatic capillary replacement system according to any one of claims 1 to 3, wherein the unclamping unit comprises:
a noncircular release pin which is inserted into an operation space connected to the clamping part of the clamping loader;
a lift member which rotatably supports the release pin;
a lift drive part disposed on the sub-stage, wherein the lift drive part drives the lift member to move upward and downward; and
a pin drive part which rotates the release pin,
wherein the clamping part of the clamping loader is spread or narrowed depending on a state of rotation of the release pin in order to clamp or release the capillaries.

5. The automatic capillary replacement system according to any one of claims 1 to 3, wherein the first drive part comprises:
a first rack gear part disposed on the base;
a first drive gear connected to the first rack gear part; and
a first drive motor disposed on the main stage, wherein the first drive motor drives the first drive gear to rotate.

6. The automatic capillary replacement system according to any one of claims 1 to 3, wherein the second drive part comprises:
a second rack gear part disposed on the main stage;
a second drive gear connected to the second rack gear part; and
a second drive motor disposed on the sub-stage, wherein the second drive motor drives the second drive gear to rotate.

7. The automatic capillary replacement system according to any one of claims 1 to 3, wherein the third drive part comprises:
a third rack gear part disposed on the main stage;
a third drive gear connected to the third rack gear part; and
a third drive motor disposed on the capillary collecting/supplying unit, wherein the third drive motor drives the third drive gear to rotate.
